(19) United States
(12) Patent Application Publication
(10) Pub. No.: US 2014/0257840 A1
(43) Pub. Date: Sep. 11, 2014

(54) PRECISE ENGAGMENT IN A MEDICAL INFORMATION HANDLING SYSTEM

(71) Applicant: Health Symmetric, Inc, Los Angeles, CA (US)

(72) Inventors: RICHARD J. CARDONE, AUSTIN, TX (US); DANNY CHU, WEST HOLLYWOOD, CA (US); JAY HOLTZ, AUSTIN, TX (US); DAVID SMITH, AUSTIN, TX (US)

(73) Assignee: HEALTH SYMMETRIC, INC, LOS ANGELES, CA (US)

(21) Appl. No.: 14/200,227

(22) Filed: Mar. 7, 2014

Related U.S. Application Data
(60) Provisional application No. 61/774,303, filed on Mar. 7, 2013.

(51) Int. Cl. G06F 19/00

(52) U.S. Cl. CPC G06F 19/3456
USPC 705/2

(57) ABSTRACT

A medical information handling system executes a medical application with which a client device is communicatively coupled to support presentation of a graphical user interface for the medical application in a display of the client device. The medical information handling system also executes an injection engine. The injection engine retrieves data from a remote data source among a set of data sources including a pharmaceutical database, an insurance database, and a public health database and correlates the retrieved data with at least one medical input entered via the graphical user interface. The injection engine selects a message content from among a positive message, negative message and neutral message based upon the at least one medical input and the retrieved data and injects into the graphical user interface a message containing the selected message content.

### BACKGROUND OF THE INVENTION

The present disclosure relates in general to data processing and, in particular, to facilitating communication between medical care providers, patients, and third party service and product suppliers.

Until recently, pharmaceutical companies, medical device manufacturers, and other medical suppliers marketed their products directly to physicians, hospitals, and other care providers. These marketing efforts often included cash payments, free meals, trips, tickets to sporting events, and other gifts to care providers. According to Pew Charitable Trusts, in 2012 the pharmaceutical companies alone spent more than $15 billion on direct-to-physician marketing and promotions.

On Aug. 1, 2013, The Physician Payments Sunshine Act (Sunshine Act) came into effect in the United States. The goal of this law is to improve patient care and lower the cost of healthcare by requiring manufacturers of pharmaceutical and biological drugs, medical devices, and medical supplies to report when they transfer goods that are worth over $10 to physicians or teaching hospitals. The Sunshine Act increases transparency in physician-industry relationships to reduce the potential for conflicts of interest that could affect patient care. Although the Sunshine Act does not dictate how pharmaceutical, device, and medical supply companies spend their marketing dollars, many of the previous marketing practices are likely to be modified or discontinued. For example, the Sunshine Act is expected to effectively redirect or eliminate 60-80% of current marketing expenditures in the pharmaceutical industry.

The present disclosure recognizes that medical service, product and device companies need to find new ways to market and educate the public about their offerings. In addition, physicians and patients need to find new ways to get information on the products and services they need.

### BRIEF SUMMARY

In one or more embodiments, the basic need for effective communication in the new regulatory environment is met through one or more techniques that can be used to improve quality of care, improve the information available to patients, and increase compliance with medical standards.

In one aspect, communication between medical providers, patients and remote data sources is facilitated so that quality of care can be improved. The remote data sources can include, but are not limited to the following: medical service providers; medical device manufacturers; medical product and drug companies; government agencies; standards bodies; insurance companies; educational institutions; patient support groups; medical journals and databases; and in-house patient records, standards of care, quality measurements and other digitized data owned by the practice or institution. In one embodiment, this communication facility is implemented in a medical information handling system, such as an Electronic Health Records (EHR) system, that care providers use to manage their patients.

In another aspect, quality of care can be improved by bringing together data from disparate sources during patient/care provider interactions. For example, during a consultation, a doctor may enter a new diagnosis for a patient into a medical information handling system. Upon entry, the system can retrieve and display data from the practice's standards of care database, from the patient's insurance company about eligibility and coverage amounts, and from government agencies about quality measures and outcomes using different treatments. Having this data available immediately allows the doctor and patient to have an informed discussion about the best course of action. In addition, automatically aggregating this information at the time it is needed (i.e., in real time) saves both doctor and patient time, reduces the need for follow-up consultations, improves data reliability, and, in general, makes the delivery of medical services more efficient. Points in time at which remote or external data are integrated into a medical information handling system are referred to herein as injection points.

In yet another aspect, digital advertising is employed to facilitate communication between medical suppliers and care providers. As noted above, government regulations and/or ethics standards can reduce or eliminate the ability of medical suppliers to persuade care providers to use their products with direct marketing incentives. In one embodiment, a medical information handling system supports the placement of advertisements at specific injection points in an application. One benefit of introducing an advertising model into medical information handling systems, such as EHR systems, is that the cost of such software to care providers can be reduced or eliminated. Medical information handling systems—and EHR systems in particular—are expensive and can be a heavy burden on small medical practices, independent practitioners, and practices and institutions in underserved areas. The disclosed use of advertisements in a medical information handling system enables new funding models that require less upfront investment.

According to one particular embodiment, one injection point is when a care provider enters a prescription for a drug for a patient into the medical information handling system. The medical information handling system consults the patient's medical record, information about one or more medical problems, and information about the drug or medical device. The medical information handling system can also consult a library of promotional information supplied by pharmaceutical companies and/or medical device companies to determine if an advertisement should be injected into an on-screen presentation at the injection point.

In yet another aspect, the medical information handling system presents a presentation including contextual social recommendations. An example might be as follows: “Your colleague, Dr. John Smith, recently prescribed Prilosec OTC® to treat a similar patient's heartburn. Would you like to learn more?” Another example might be as follows: “Dr. John Jones is one of the top physicians in this network, and he prescribes Prilosec OTC® for heartburn. Learn more here!” (Prilosec OTC® is a registered trademark of AstraZeneca.)

In yet another aspect, if a care provider or patient desires additional information, a selectable element in the presentation can be selected to invoke an informative promotional presentation by the medical information handling system, for example, featuring detailed information and videos provided by a pharmaceutical and/or medical device company, as well as testimonials on the drug from care providers and/or patients. If a care provider is interested in a drug or medical device after reviewing the promotional materials, the care provider can initiate contact with a sales representative, request samples, and/or prescribe the drug and/or medical device by making the appropriate selection within the presentation of the medical information handling system. In embodiment, multiple modalities of contact with a sales representative can be supported through the medical information handling system. For example, the care provider can request an in-person appointment, engage in an online chat, or participate in an online video conference by appropriate inputs in the presentation of the medical information handling system.

### BRIEF DESCRIPTION OF THE SEVERAL VIEWS OF THE DRAWINGS

FIG. 1 is a high level block diagram of a data processing environment in accordance with one embodiment;

FIG. 2 is a more detailed view of an exemplary embodiment of the injection engine of FIG. 1;

FIG. 3 is a high level logical flowchart of an exemplary embodiment of a method by which the injection engine of FIG. 1 injects information into a presentation of a medical application in accordance with one embodiment;

FIG. 4 depicts an exemplary graphical user interface illustrating one or more different messages that can be injected into a presentation of a medical application by the injection engine;

FIG. 5 illustrates an exemplary graphical user interface illustrating a negative message injected into a presentation of a medical application to alert a care provider to a potential medication conflict prior to prescription;

FIG. 6 depicts an exemplary graphical user interface illustrating a message injected into a presentation of a medical application, where the message contains real-time data from multiple data sources;

FIG. 7 illustrates another exemplary graphical user interface illustrating a message injected into a presentation of a medical application, where the message contains real-time data from multiple data sources;

FIG. 8 depicts an exemplary graphical user interface illustrating a promotional message injected into a presentation of a medical application;

FIG. 9 illustrates an exemplary graphical user interface illustrating an alternative promotional message injected into a presentation of a medical application;

FIG. 10 depicts an exemplary graphical user interface illustrating a colleague's recommendation injected into a presentation of a medical application;

FIGS. 11-12 illustrate an exemplary graphical user interface in which treatment recommendations and standards of care are injected into a presentation of a medical application;

FIG. 13 illustrates an exemplary graphical user interface of a scheduling function of a medical application in which an injection engine can inject treatment recommendations, promotional offers, and insurance information in accordance with one embodiment;

FIG. 14 depicts the exemplary graphical user interface of FIG. 13 following user selection of a selectable element in order to access additional information about a promoted medication or medical device;

FIG. 15 illustrates the graphical user interface of FIG. 14 after a user has selected an option to further engage with a representative of a medication or medical device; and

FIG. 16 depicts an exemplary graphical user interface of an electronic medical record (EMR) function in which one or more chief complaints are injected based on data retrieved from one or more data sources.

### DETAILED DESCRIPTION

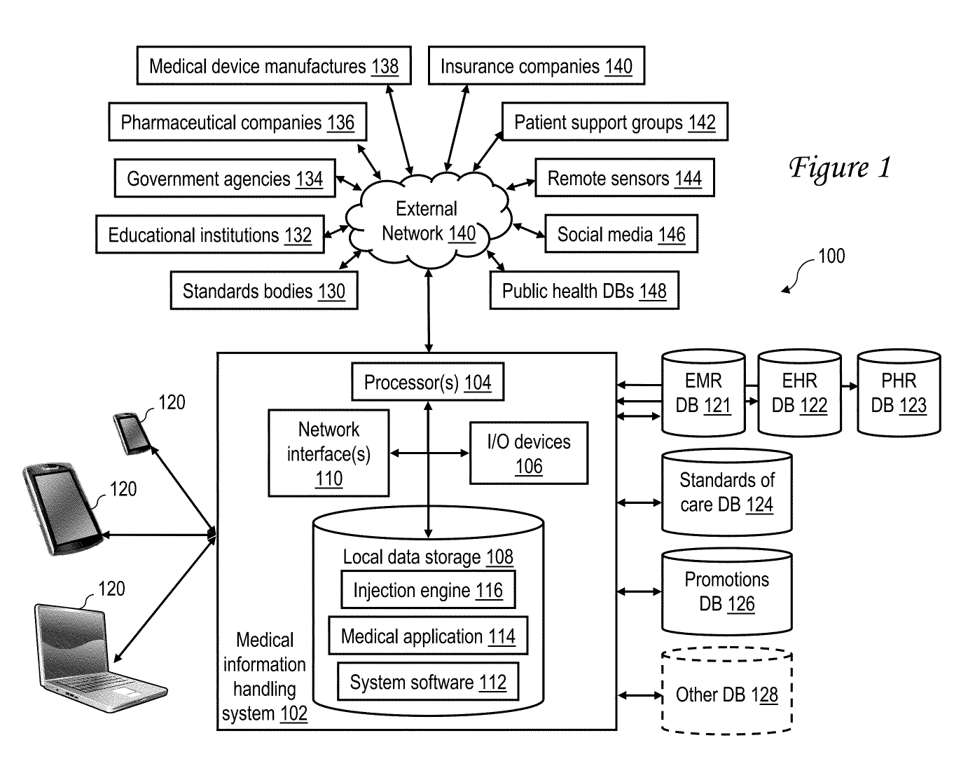

With reference now to the figures and with particular reference to FIG. 1, there is illustrated a high level block diagram of an exemplary data processing environment 100 including a medical information handling system 102 in accordance with one embodiment.

In the depicted embodiment, medical information handling system 102 includes one or more processors 104 (typically comprising one or more integrated circuits) that process data and program code, for example, to manage, access, manipulate, modify, store and present data and/or software in data processing environment 100. Medical information handling system 102 also includes input/output (I/O) devices 106, such as ports, displays, user input devices and attached devices, etc., which receive inputs and provide outputs of the processing performed by medical information handling system 102 and/or other resource(s) in data processing environment 100. Medical information handling system 102 additionally includes local data storage 108, which may include one or more volatile or non-volatile storage devices, including memories, solid state drives, optical and/or magnetic disk drives, tape drives, etc. Local data storage 108 may store, for example, program code (including software, firmware or a combination thereof) that when executed by processor(s) 104 causes medical information handling system 200 to implement at least some of the functionality described herein. In the illustrated exemplary embodiment, medical information handling system 102 includes one or more network interfaces 110 that permit medical information handling system 102 to communicate with one or more information, presentation, and/or computing resources via cabling and/or one or more wired or wireless, public or private, local or wide area networks (including the Internet).

The program code stored within local data storage 108 includes system software 112, which can include one or more operating systems and may further include a virtual machine monitor (VMM) or other platform virtualization software. System software 112 provides an execution context for one or more middleware and/or application programs, such as medical application 114 and injection engine 116. Medical application 114 can include or form a part of any medical software system, including but not limited to a medical practice management system, pharmaceutical management system, clinical decision system, medical analytics system, radiology management system, laboratory management system, disease management system, Electronic Medical Record (EMR) system, Electric Health Record (EHR) system, or a Personal Health Record (PHR) system.

In the present application, an EMR refers to a patient's digital medical record roughly corresponding to the paper charts conventionally used by care providers in medical offices, clinics, and hospitals. EMRs contain notes and information collected by and for the care providers in that office, clinic, or hospital and are mostly used by care providers for diagnosis and treatment. EMRs enable care providers to track data over time, identify patients for preventive visits and screenings, monitor patients, and improve health care quality.

EHRs include clinical data collected in providers' offices, but provide a broader view of a patient's care because they contain information from and are accessible to multiple clinicians involved in the patient's care. EHRs can also be used to share information with other health care providers and institutions, such as laboratories, specialists, hospitals, and residential care facilities.

PHRs contain the same types of information as EHRs—diagnoses, medications, immunizations, family medical histories, and provider contact information—but are designed to be setup, accessed, and managed by patients rather than care providers. Patients can use PHRs to maintain and manage their health information in a private, secure, and confidential environment.

End users, such as care providers and/or patients, can interact with medical application 114 through any of a variety of client devices 120, such as terminals, laptop or desktop computer systems, smart phones, tablets, mobile devices, etc. Client devices 120 preferably include a display in which medical application 114 (and optionally a locally executing browser or app) presents a graphical user interface through which a care provider or patient can request and/or receive information relevant to a patient, drug, medical device and/or medical therapy.

Injection engine 116, which preferably executes in the context of medical application 114, injects relevant information in presentations of medical application 114 at various injection points. To inject the relevant information, injection engine 116 may (1) gather data from a first set of data sources, which can be (but are not required to be) local to medical information handling system 102 (2) gather data from a second set of data sources, which can be (but are not required to be) external to or remote from medical information handling system 102, (3) based on the gathered data, determine and format information for presentation via one or more client devices 120, and (4) inject the information into a presentation of medical application 114 on client devices 120. Examples of data sources in the first set of data sources include EMR, EHR and PHR databases 121-123, standards of care database 124, promotions database 126, and/or optionally one or more other databases 128 that a medical practice or institution subscribes to, owns, manages, or rents. Examples of data sources in the second set of data sources include, but are not limited to, databases of standards bodies 130, educational institutions 132, government agencies 134, pharmaceutical companies 136, medical device manufacturers 138, insurance companies 140, patient support and/or advocacy groups 142, remote health sensors 144 (e.g., a patient's cardiac monitor, glucose monitor, sphygmomanometer or activity sensor(s)), social media database(s) 146, and public health database(s) 148.

Communication exchanges between injection engine 116 and data sources in the first and second sets of data sources may use publicly available communication protocols, or alternatively, may use predetermined customized protocols. In various implementations, the communication exchange between injection engine 116 and data sources in the second set of data sources can be free of charge, or alternatively, may require some form of payment from one party to the other. For example, injection engine 116 and/or the entity operating medical information handling system 102 may require payment for injection of advertisements and/or other information from the first and/or the second set of data sources. Alternatively or additionally, the operator of the medical information handling system 102 may be required to make payment to access information from data sources that require paid subscriptions.

Those skilled in the data processing arts will appreciate that the arrangement of software and hardware components depicted in FIG. 1 is just one of many possible configurations falling within the scope of the appended claims. For example, in some embodiments, medical information handling system 102 can execute on one or more physical or virtual computer systems, form part of a cluster of systems, can include load-balancing hardware and software, and can work in conjunction with additional hardware and/or software components not specifically shown in FIG. 1 (e.g., web server, middleware, security software, encryption software, etc.). For example, injection engine 116 can execute on one physical platform, or alternatively, be distributed to run on multiple physical platforms, including client devices 120. Further, medical information handling system 102 may execute medical application 114 and injection engine 116 and provide access to the first set of data sources as part of a software-as-a-service (SaaS) offering subscribed to by a medical practice having one or more of client devices 120. Alternatively, a medical practice may itself operate medical information handling system 102 and locally maintain one or more data sources in the first set of data sources.

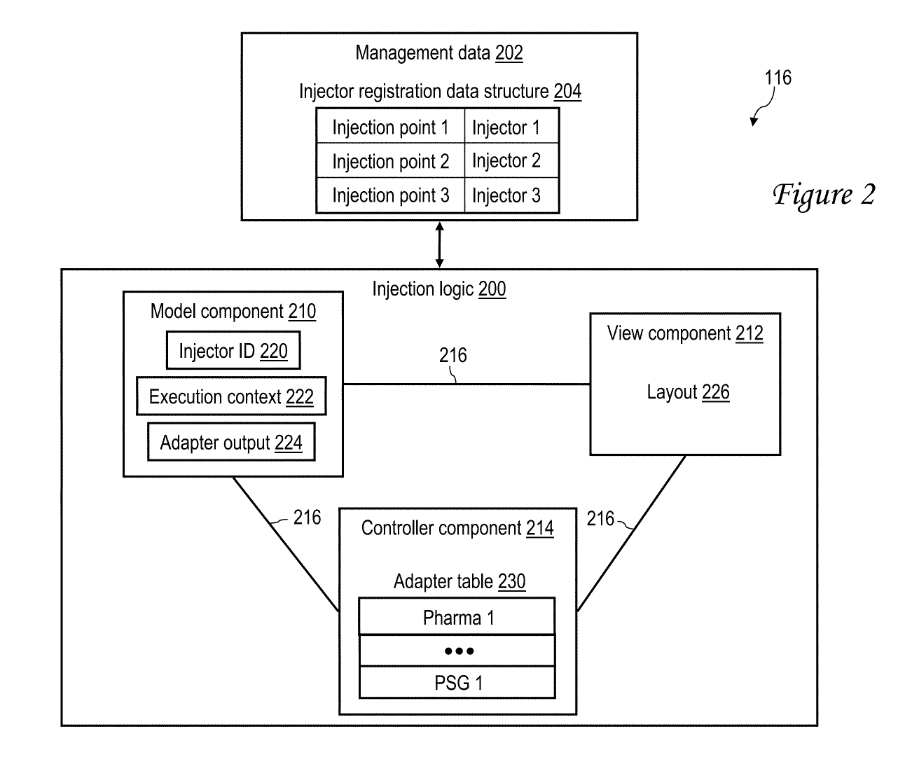

Referring now to FIG. 2, there is depicted a more detailed view of an exemplary embodiment of injection engine 116 of FIG. 1. As indicated, injection engine 116 includes injection logic 200 and associated management data 202 accessed by injection logic 200.

Management data 202 includes an injector registration data structure 204, such as a table. Injector registration data structure 204 associates injection points in medical application 114 with injectors registered at those injection points, where “injection points” are defined as the locations in the program code of medical application 114 where program code and/or data from the second set of data sources can be integrated into a presentation of medical application 114 and “injectors” are defined as the program code and/or data injected at these injection points.

The information in injector registration data structure 204 can be read by injection logic 200 at runtime to determine what program code and/or data should be injected at any injection point during execution of medical application 114. In some embodiments, management data 202 can also be used to statically or dynamically modify injection point processing, to collect runtime statistics on injection execution, or to perform any other management functions related to injection. Data structures supporting these ancillary management functions are not explicitly depicted in FIG. 2. Those skilled in the art will appreciate that injector registration data structure 204 of FIG. 2 is only one of the possible data structure that can be employed to manage injection data. Other embodiments could use code introspection, mixins, annotations configuration files, database tables, or other techniques to statically or dynamically create, read, update or delete injection-related control information.

In the depicted embodiment, injection logic 200 employs a Model-View-Controller design pattern and accordingly includes a model component 210, a view component 212, and a controller component 214. Model component 210, view component 212 and controller component 214 communicate through a channel 216. In at least one embodiment, channel 216 can include one or more software mechanisms for communication, including but not limited to, direct method calls, asynchronous events, message queues, and streams.

Model component 210 manages the data used by or generated by injection engine 116. Within model component 210, an injector undergoing execution is identified with a unique name expressed as its injector ID 220. In addition, the input parameters, intermediate results and temporary data structures used during injector execution form an execution context 222. Any output generated during injector execution is buffered in an adapter output data structure 224.

View component 212 of injection logic 200 manages the final formatting of data returned from local or remote sources by controller component 214. View component 212 receives raw result data and formats the raw result data for rendering on client devices 120. View component 212 also prioritizes information when more than one data source has returned information relevant to a request. To perform its tasks, view component 212 uses data in execution context 222 as well as other data stored in model component 210.

Controller component 214 communicates with data sources in the first and second sets of data sources, as shown, for example, in FIG. 1. Controller component 214 coordinates all communication transactions and handles all runtime errors. Controller component 214 includes an adapter table 230 containing the protocol code needed to communicate with each data source associated with the injector identified by injector ID 220. Each data source preferably has an associated adapter, and the various adapters are preferably independent, reusable components that can be shared between injectors. As one example, FIG. 2 illustrates an adapter table 230 including a first adapter “Pharma 1” for communicating data with a database of a pharmaceutical company 136 and a second adapter “PSG 1” for communicating data with a database of a patient support group 142. To perform its tasks, controller component 214 uses the data in execution context 222, uses adapter output 224 to post the results of adapter execution, and uses other data stored in model component 210.

Those skilled in the art will appreciate that many alternative approaches can be utilized to implement injectors and their constituent subcomponents. In some implementations, the strict separation of model, view and controller components can be relaxed to simplify coding or to improve performance. In other implementations, the Model-View-Controller design pattern does not have to be used at all: As long as injectors can (1) be associated with injection points, (2) communicate with data sources, and (3) return their results to the medical information handling system 102, any injector design will suffice.

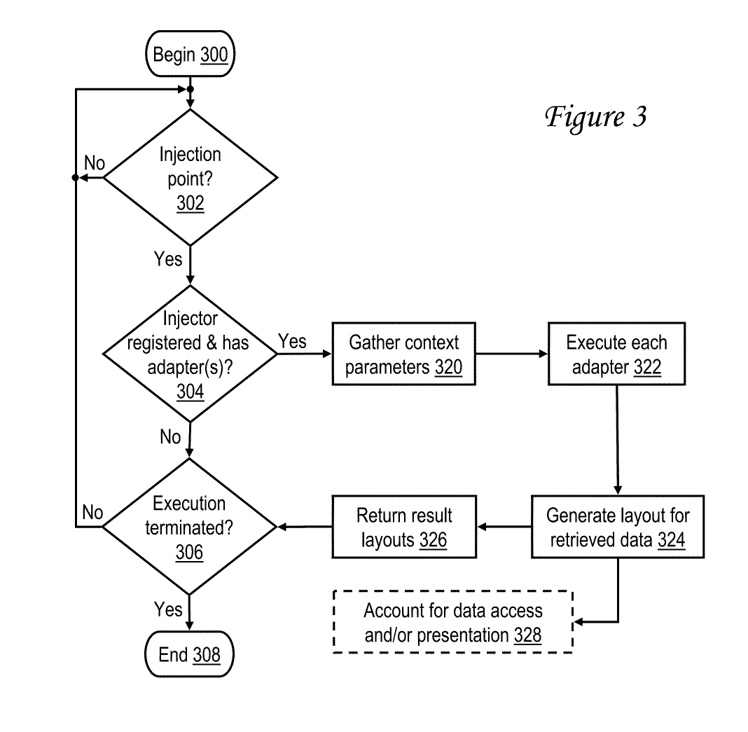

With reference now to FIG. 3, there is illustrated a high-level logical flowchart of an exemplary embodiment of a method by which the injection engine 116 of FIG. 1 injects information into a presentation of a medical application 114 in accordance with one embodiment. The illustrated process begins at block 300, for example, in response to execution of a predetermined portion of medical application 114. At block 302 injection engine 116 determines whether or not execution of medical application 114 is approaching or has reached an injection point identified in injector registration data structure 204. If not, injection engine 116 awaits an injection point, as indicated by the process returning to block 302. In response to a determination at block 302 that injection engine 116 is approaching or has reached an injection point, injection engine 116 determines at block 304 whether or not the injection point has a registered injector that has at least one associated adapter for the relevant data source. For example, in the embodiment depicted in FIG. 2, injection engine 116 makes the determination illustrated at block 304 by reference to injector registration data structure 204 and adapter table 230. In response to a negative determination at block 304, the process proceeds to block 306, which illustrates injection engine 116 further determining whether medical application 114 has terminated execution. If not, the process returns to block 302, which has been described. If, however, injection engine 116 determines that execution of medical application 116 is terminating, the process of FIG. 3 ends at block 308.

Returning to block 304, in response to an affirmative determination, then injection engine 116 gathers all context parameters required by the injection point and passes those context parameters to model component 210 for storage in execution context 222 (block 320). Controller component 214 then executes each of its adapters to obtain data from a respective data source among the second set of data sources utilizing the associated communication protocol (block 322). Each adapter's output is stored in adapter output database 224 of model components 210. As the adapter(s) complete data retrieval, view component 212 formats the retrieved data to obtain a desired layout 226 (block 324). Depending on the embodiment, the layout 226 determined by view component 212 is returned synchronously or asynchronously to medical application 114 for presentation via client devices 120. As further illustrated at block 328, injection engine 116 may optionally further account for the access to the data by the adapter and/or the presentation of the data via medical application 114 and client devices 120. The accounting may include, for example, incrementing a count of times data has been presented from a particular data source within an accounting time period (e.g., day, week, month, etc), updating a record of a quantity of data accessed from a given data source within an accounting time period, initiating an electronic financial transaction (e.g., wire transfer or ACH payment), etc. From block 326, the process then returns to block 306, which has been described.

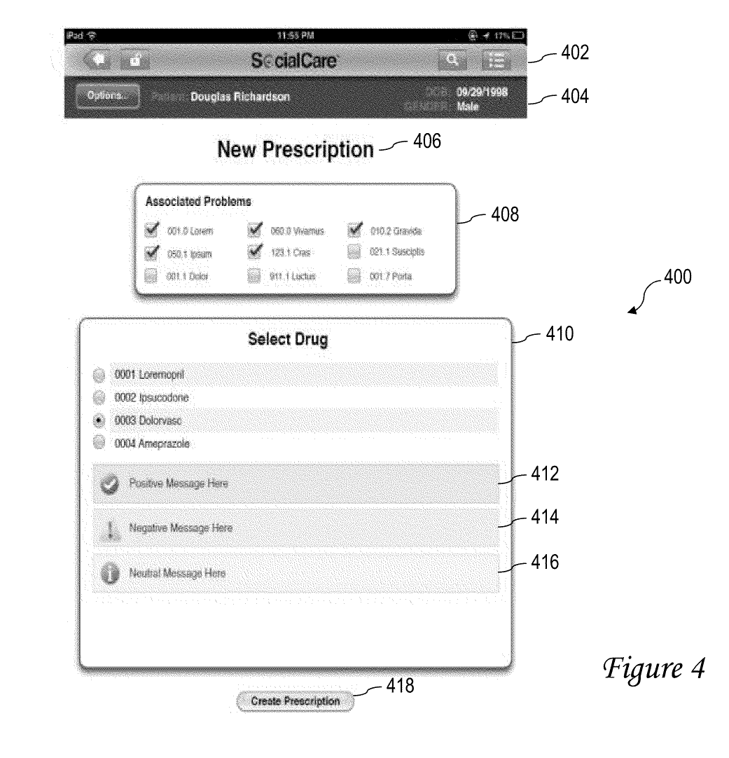

Referring now to FIG. 4, there is depicted an exemplary graphical user interface 400 of a client device 120 illustrating different messages that can be injected into a presentation of an EHR function of a medical application 114.

As illustrated, exemplary graphical user interface 400 of client device 120 includes a navigation toolbar 402 that can be utilized to navigate within and between records, for example, within and between records in EMR database 121 or EHR database 122. Adjacent navigation toolbar 402 is a record summary 404 providing summary information regarding a currently selected record, such as the patient name, date of birth (DOB), and gender. Graphical user interface 400 additionally includes a textual title 406 (in this case “New Prescription”) indicating the general classification of information to be presented to and/or input by a care provider via graphical user interface 400. In the illustrated example, the creation of a new prescription in the patient's EMR or EHR requires entry of one or more complaints in an input box 408 including one or more checkboxes, as well as selection of a prescribed drug and/or medical device through an input box 410, which in this example includes a series of radio buttons allowing the care provider to select one or more drugs and/or medical devices to be prescribed.

In the illustrated example, graphical user interface 400 further includes one or more messages 412, 414, and/or 416 injected by injection engine 116 in accordance with the process of FIG. 3. As indicated, messages 412-416, which are presented by medical application 114 and injection engine 116 in response to receipt of one or more inputs via graphical user interface 400, may include content that is positive, negative, or neutral (in this case, as regards the inputs received via graphical user interface 400). Messages of differing content are preferably differentiated by visually distinctive presentation attributes, such as colors, typefaces and/or graphics (e.g., a check mark for positive message, a warning sign for a negative message, and an information sign for neutral message). Messages 412-416 can be generated, for example, as a result of multi-source data fusion drawing on data sources such as pharmaceutical literature, hospital records, case histories, and the particular patient's EHR, etc.

Based on the content of the one or more messages 412-416 injected into graphical user interface 400, a care provider may elect to update the patient's record, for example, by creating a new prescription through selection of button 418, or alternatively, may elect to cancel the update to the patient's record, for example, by navigating back to a prior screen utilizing toolbar 402.

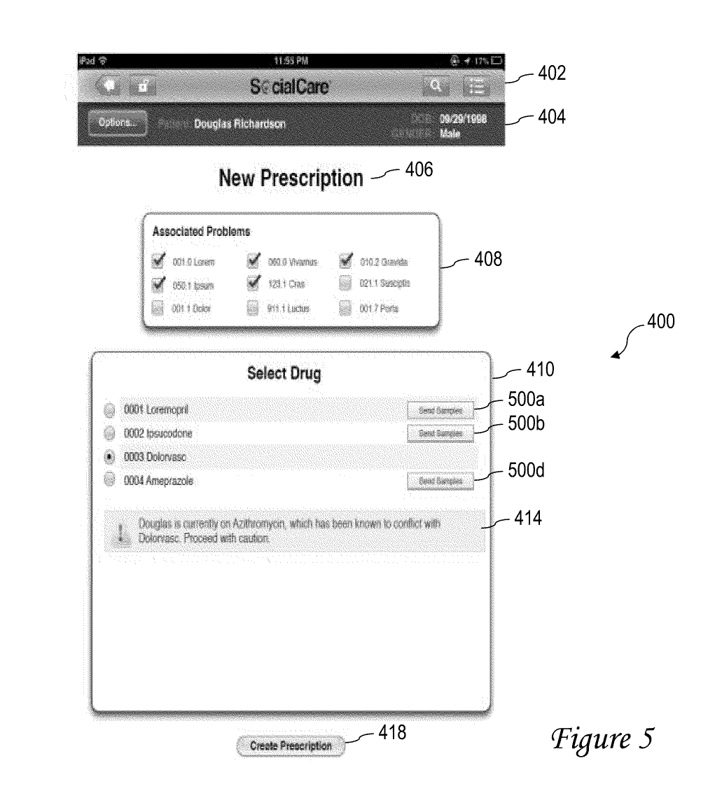

FIG. 5 illustrates a specific example of the injection of a negative message to alert a care provider to a potential medication conflict prior to prescription. In the specific example shown, a care provider operating a client device 120 has chosen Dolorvasc as a drug to be prescribed to address the patient's symptoms entered in input box 408. However, information from one or more of the data sources (pharmaceutical companies 136, EMR, EHR or PHR databases 121-123, etc.) contraindicates this choice. Consequently, injection engine 416 injects a negative message 414 with presentation attributes signifying its negative content and with content specifically discussing the potential problem: “Douglas is currently on Azithromycin, which has been known to conflict with Dolorvasc. Proceed with caution.” In some cases, the injection of a negative message 414 does not prohibit the workflow of medical application 116 from proceeding (e.g., the care provider can still enter the new prescription via selection of button 418); however, in some implementations, injection engine 416 is configured such that the severity of the content of negative message 414 can cause injection engine 416 to dynamically create an injection point that halts the workflow of medical application 116, for example, by disabling the creation of the new prescription and injecting program code that visually indicates the disabling of button 418 (e.g., button 418 is “grayed out”). As an alternative to halting the workflow, injection engine 416 may instead inject program code that initiates an additional workflow, such as automatically scheduling a higher level review of a patient's course of treatment by an institutional review board (IRB).

FIG. 5 further illustrates that the messages injected by injection engine 116 into the graphical user interface 400 presented by medical application 114 can include promotions. These promotions can include non-interactive messages, for example, that name or tout a drug, medical device or therapy, as well as interactive messages that permit a care provider to selectively initiate further interaction with an advertiser and/or its representative. In the present case, graphical user interface 400 includes interactive promotions in the form of Send Samples buttons 500a, 500b and 500d, which are injected by injection engine 116 based on the pharmaceutical companies that make Loremopril, Ipsucodone, and Ameprazole paying for placement of these promotions (i.e., buttons) adjacent the listing of their respective products within input box 410. It should be noted that in the illustrated example, injection engine 116 is configured to refrain from injecting a similar promotion adjacent the listing of the contraindicated medication Dolorvasc despite its maker paying for placements of such promotions in response to the determination of the negative content of negative message 414 and the association of the negative content with the medication Dolorvasc. It should be appreciated that in various embodiments, injection engine 116 can determine the negative content of negative message 414 based not only on drug interactions, but also patient allergies and other factors.

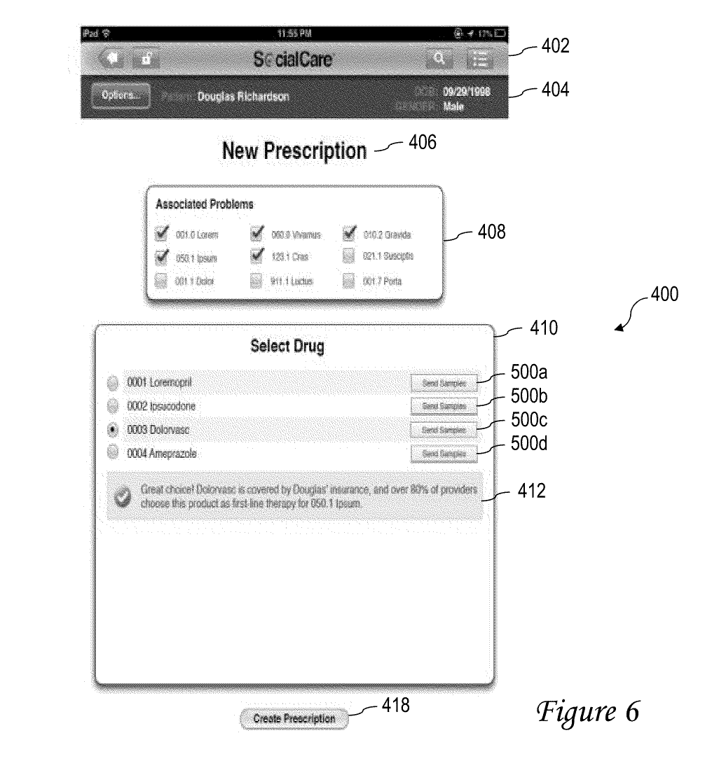

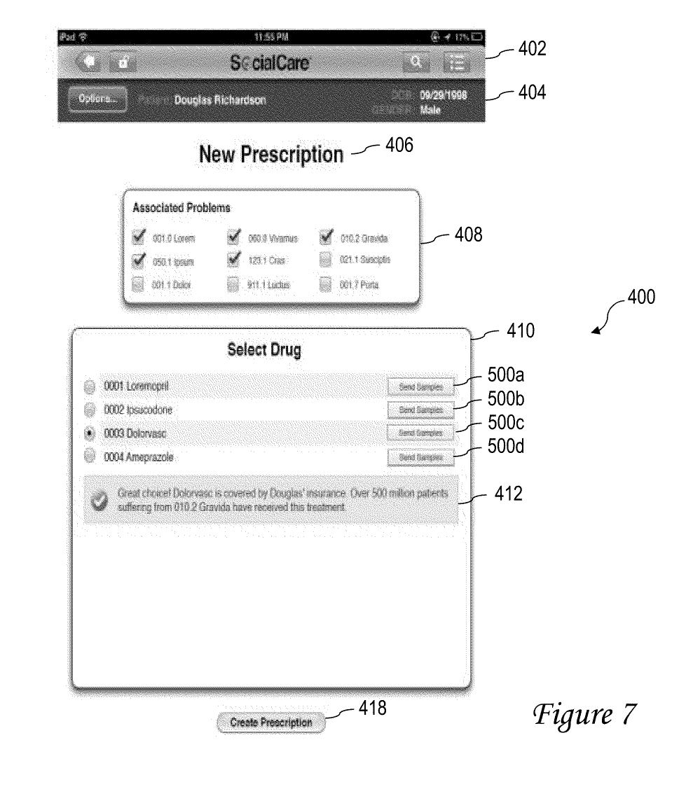

Referring now to FIG. 6, there is depicted an exemplary graphical user interface 400 illustrating a message (e.g., a positive message) injected into a presentation of a medical application, where the message contains real-time data from multiple data sources (e.g., insurance data sources, medical data sources, statistical data sources, and/or encounter-specific data). In exemplary graphical user interface 400, the care provider operating a client device 120 has again selected Dolorvasc in input box 410 to address the symptoms input in input box 408. In response to the inputs received via both of input boxes 408 and 410, injection engine 416 injects a positive message 412 into graphical user interface 400. Positive message 412 combines data from multiple sources, including data from the patient's diagnosis (e.g., input in message box 408), the patient's insurance plan (e.g., retrieved from a database of one of insurance companies 140), and colleague behavior (e.g., selected from EMR database 121, EHR database 122 and/or a national public health database 148), which are all related to a prescribed (or potentially prescribed) medication. Injection engine 116 combines these insurance, medical, and encounter-specific data in real time to obtain a positive message of meaningful content, such as: “Great choice! Dolorvasc is covered by Douglas' insurance, and over 80% of providers choose this product as first-line therapy for 050.1 Ipsum.” FIG. 7 illustrates an alternative positive message 412 including industry-wide statistical data rather than information regarding colleague behavior: “Great choice! Dolorvasc is covered by Douglas' insurance. Over 500 million patients suffering from 010.2 Gravida have received this treatment.” The positive messages 412 as shown in FIGS. 6-7 can be injected into graphical user interface 400 in response to or independently of any promotional fee payment by the maker of the drug Dolorvasc.

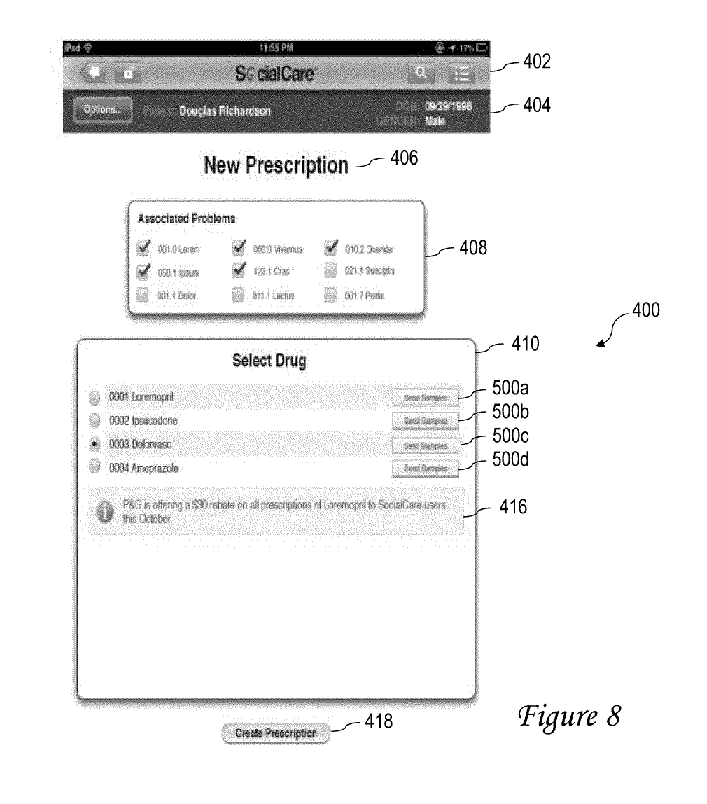

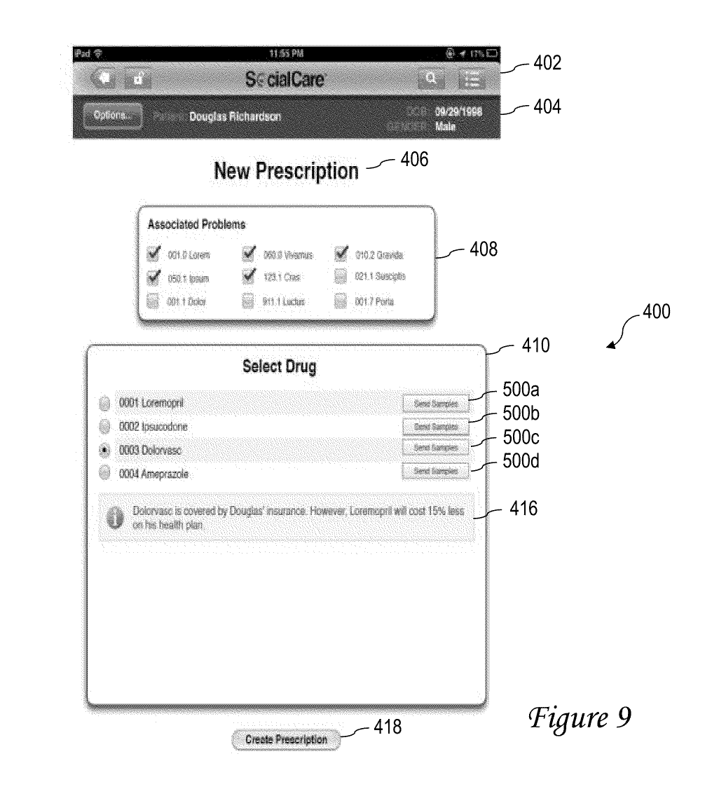

Referring now to FIG. 8, depicts an exemplary graphical user interface 400 illustrating a promotional message (e.g., a neutral message) injected by injection engine 116 into a presentation of a medical application 114. In the specific example shown, a care provider operating a client device 120 has selected Dolorvasc in input box 410 to address the patient's symptoms input in input box 408. In response to one or more of the inputs received from input box 408 and the inputs received from input box 410, injection engine 416 injects a neutral message 416 containing a promotional offer into the presentation of medical application 114 to help guide the choice of prescription via input box 410. In the specific example given, the care provider has chosen Dolorvasc to address the patient's symptoms. However, data accessed by injection engine 116 in real time from one or more of the data sources (e.g., a database of one of pharmaceutical companies 136 or a local promotion database 126) indicates that a rebate is currently available for one of the competing drugs, Loremopril. Consequently, injection engine 116 injects into the presentation of medical application 114 the following neutral message: “P & G is offering a $30 rebate on all prescriptions of Loremopril to SocialCare users this October.” In this case, a promotional fee associated with the presentation of neutral message 416 may be accounted to the pharmaceutical company at block 328 of FIG. 3. FIG. 9 illustrates an alternative neutral message 416: “Dolorvasc is covered by Douglas' insurance. However, Loremopril will cost 15% less on his health plan.” Injection engine 116 can inject the neutral message 416 shown in FIG. 9 in lieu of the message given in FIG. 8 based on, for example, data retrieved in real time from the patient's insurance company 140 indicating better pricing for an alternative medication. In this case, injection engine 116 may account a promotional fee for the presentation of neutral message 416 to the patient's insurance company.

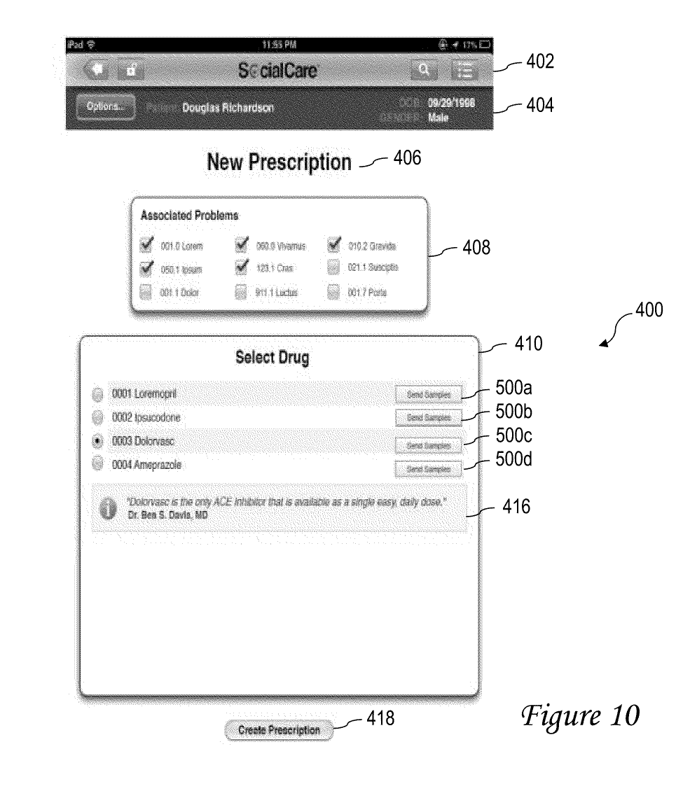

Referring now to FIG. 10, there is depicted an exemplary graphical user interface 400 illustrating injection of a colleague's recommendation into a presentation of a medical application. As in the examples above, the care provider operating a client device 120 has selected Dolorvasc in input box 410 to address the patient's symptoms input in input box 408. In response to the inputs entered in one or both of input boxes 408 and 410, injection engine 416 injects a neutral message 416 featuring a doctor's recommendation: “‘Dolorvasc is the only ACE inhibitor that is available as a single easy, daily dose.’ Dr. Ben S. Davis, MD.” In various implementations and/or operating scenarios, this recommendation can be injected from promotions database 126, a database of a pharmaceutical company 136, a database of an insurance company 140, another patient's EHR record from EHR database 122, or another database, such as a social media database 146.

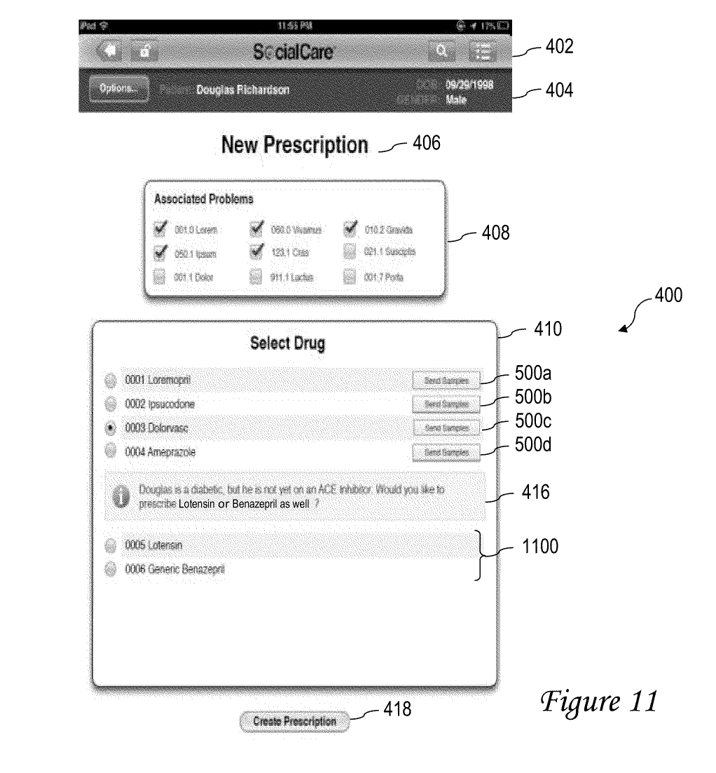

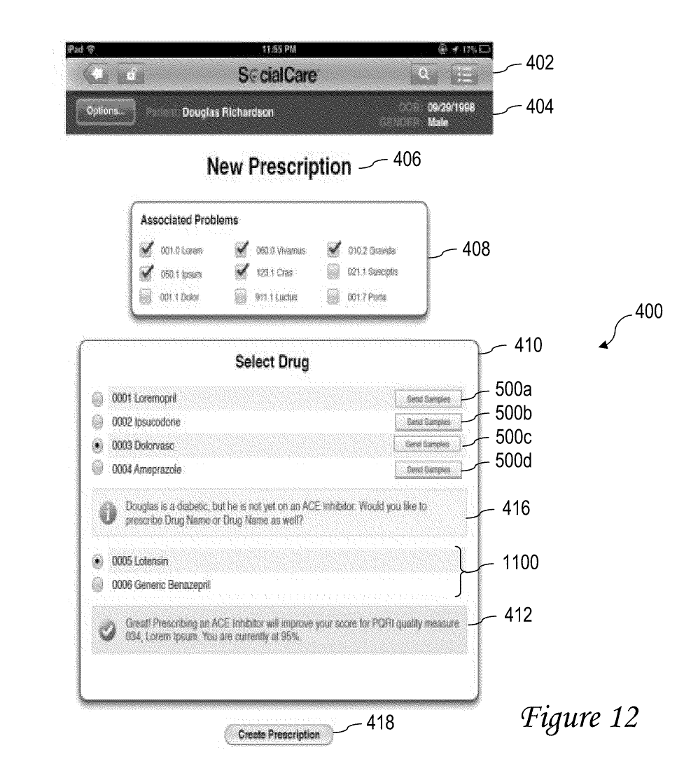

With reference now to FIGS. 11-12, there is illustrated an exemplary graphical user interface 400 illustrating injection of treatment recommendations and standards of care into a presentation of a medical application 114. As in the examples above, the care provider operating a client device 120 has selected Dolorvasc in input box 410 to address the patient's symptoms input in input box 408. In response to the inputs entered in one or both of input boxes 408 and 410, injection engine 416 accesses data from one or more of the data sources in the first and second sets of data sources (e.g., remote sensors 144 or EHR database 122) indicating that the patient has an additional untreated condition. In response to this data, injection engine 116 injects a neutral message 416 including a treatment recommendation as follows: “Douglas is a diabetic, but he is not yet on an ACE inhibitor. Would you like to prescribe Lotensin or Generic Benazepril as well?” In addition, injection engine 116 injects program code into medical application 114, causing medical application 114 to present an additional input field 1100 in input box 410 that permits prescription of a drug, medical device or therapy (e.g., in this case Lotensin or Generic Benazepril) for the heretofore untreated condition.

FIG. 12 further illustrates that, in accordance with at least one embodiment, injection engine 116 is further configured, in response to a care provider selecting a drug, medical device or therapy based on a treatment recommendation, to inject a message affirming the selection as improving the care provider's standard of care score. For example, in FIG. 12, injection engine 116 injects a positive message 412, stating: “Great! Prescribing an ACE inhibitor will improve your score for PQRI quality measure 034, Lorem Ipsum. You are currently at 95%.”

In the foregoing description, various embodiments have been described in which messages, including promotional messages, are injected into a medical application. Although these messages have heretofore been described with reference to a particular component of an exemplary medical application (e.g., prescription entry into a patient's EMR or EHR) it should be appreciated that the described engagement with medical care providers can also be applied to any other feature set of medical application, including without limitation patient scheduling, patient portal, care provider notes, etc. Further, the information placed within the messages may vary, and in various embodiments may include special offers (discounts, rebates, coupon cards, etc.), information related to insurance coverage, best practices, quality metrics, social media endorsements, industry-wide or governmental statistics, etc. Further, when the engagement includes promotions or advertisements, the form of advertisement may vary and in various embodiments can include, without limitation, electronically requested samples, digital communication with drug and device representatives, rich media advertisements, traditional banner advertisements, advertisements targeted by patient information (e.g., medical history, demographics, etc.) and/or care provider information (e.g., prior responses to advertisements, demographics, length in practice, prescription patterns, etc.), and/or selective presentation of advertisements based on user permissions or roles (e.g., doctor, nurse practitioner, medical office administrator, clerical staff, insurance claims staff, etc.).

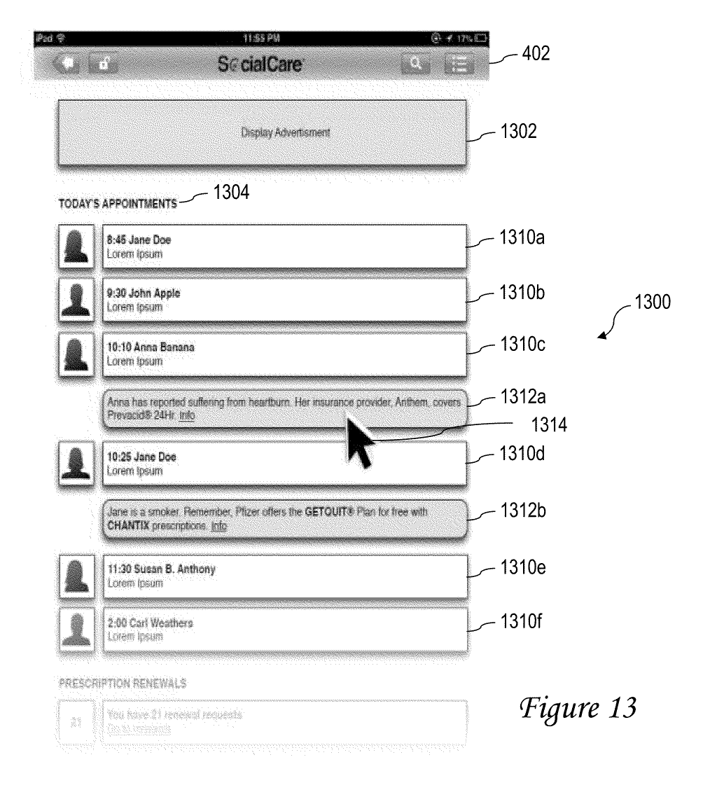

Turning now to FIG. 13, there is illustrated is an exemplary graphical user interface 1300 of a scheduling function of a medical application 114 in which injection engine 116 can inject treatment recommendations, promotional offers, and insurance information in accordance with one embodiment. Exemplary graphical user interface 1300 includes a navigation bar 402 as previously described, a textual title 1304 (in this case “Today's Appointments”) and a time-ordered listing of appointments 1301a-1310f for medical care. In the illustrated example, injection engine 116 accesses data from one or more data sources and determines from at least one of the data sources (e.g., EHR database 122) that a patient named Anna, who is scheduled for a 10:10 AM appointment, suffers from heartburn. Injection engine 116 correlates this information with an identity of Anna's insurance provider and data from another data source (e.g., a database of Anna's insurance company 140) identifying a drug covered by Anna's insurance to generate and inject the following message 1312a beneath her appointment listing 1310c: “Anna has reported suffering from heartburn. Her insurance provider, Anthem, covers Prevacid® 24 Hr.” In this case, message 1312a may be generated and presented without any accounting for data access or a promotional fee. Injection engine 116 may inject a similar message 1312b presented in association with the appointment listing 1310d of Jane Doe. In this case, injection engine 116 accesses information from one or more of the data sources (e.g., EHR database 122) indicating that Jane is a smoker and correlates this information with a paid pharmaceutical promotion to generate the message 1312b presented beneath her appointment listing 1310d: “Jane is a smoker. Remember, Pfizer offers the GETQUIT® Plan for free with CHANTIX prescriptions.”

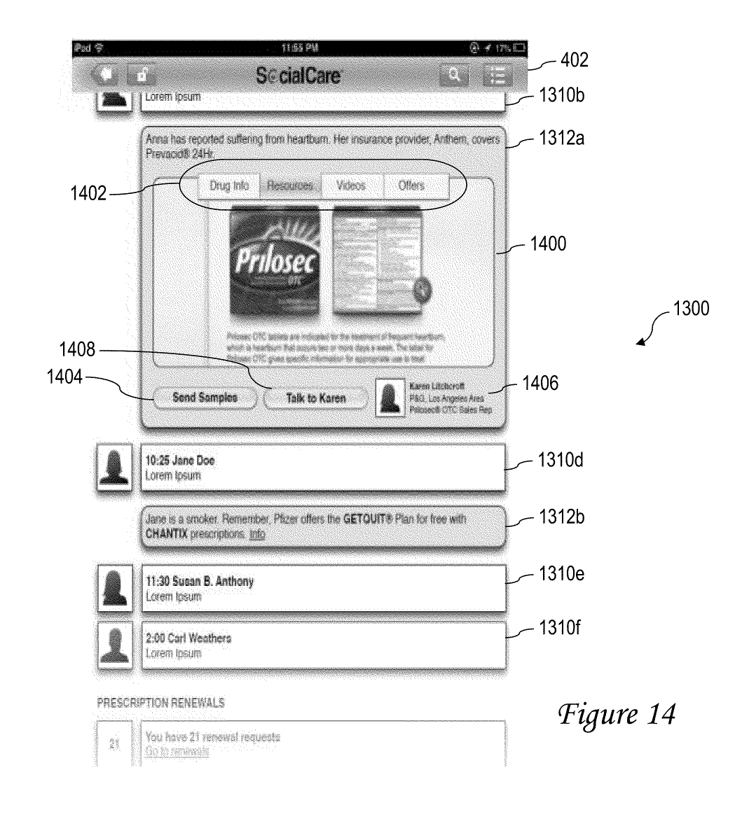

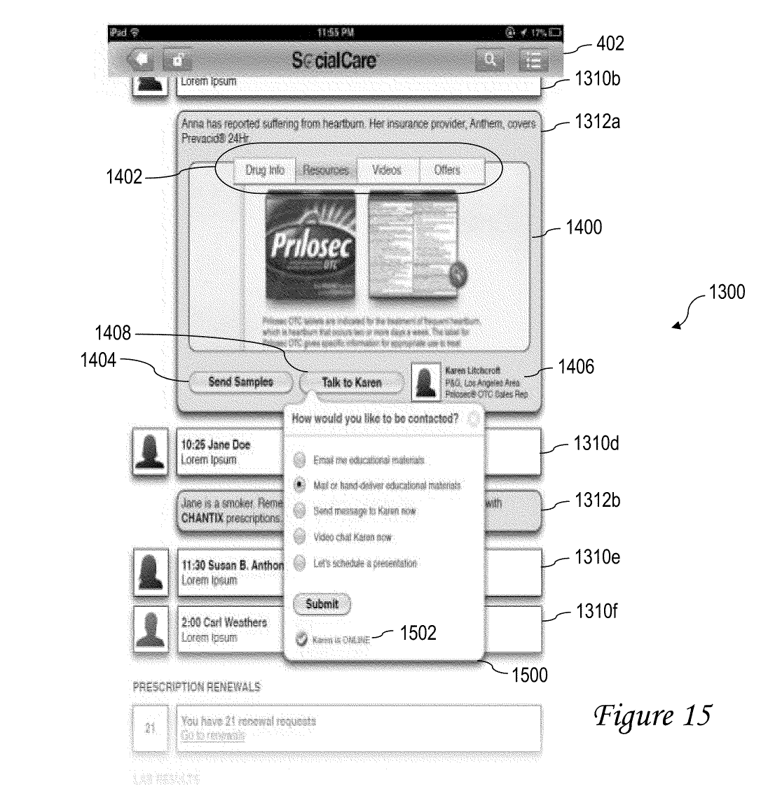

In both messages 1312a and 1312b, a link (“Info”) is provided that enables a care provider to selectively obtain additional information or engage with a representative of a drug or device manufacturer or distributor. For example, if a user of a client device 120 selects the link in message 1312a (or in some embodiments, message 1312a itself) utilizing cursor 1314 or another selection modality, injection engine 116 and medical application 114 cause message 1312a to be expanded to provide user access to additional information and resources regarding the subject of message 1312a. In the example shown in FIG. 14, message 1312a is expanded (or replaced) to provide a landing page including a rich media presentation 1400 regarding the featured drug. The rich media presentation, which may include sound, images, graphics and/or video, further includes a control bar 1402 that enables user selection and viewing of additional information, resources, videos and promotional offers related to the featured drug. Expanded message 1312a can further include a button 1404 that can be selected by a user to order samples of a drug or medical device, representative profile information 1406 (e.g., name, photograph, company name and contact information) of a representative of a manufacturer or distributor, and a button 1408 that can be selected to enable communication (including live electronic communication) with the representative.

In response to user selection of button 1408 on the user's client device 120, injection engine 116 and medical application 114 cause an option menu 1500 to be presented in graphical user interface 1300. Option menu 1500 can include options that invite email communication, hard copy communication, instant messaging communication, video chat communication (e.g., Facetime®), or scheduling of an online or live presentation with the representative identified by representative profile information 1406. In at least some embodiments, injection engine 116 injects real-time content retrieved from a data source into the graphical presentation of communication options, such as an online status indication 1502 indicating whether the representative of the featured medication is currently online and thus available for a live textual or video chat. In response to selection of one of the options in option menu 1500, medical application 114 executes functionality to facilitate the desired engagement between the care provider and the representative.

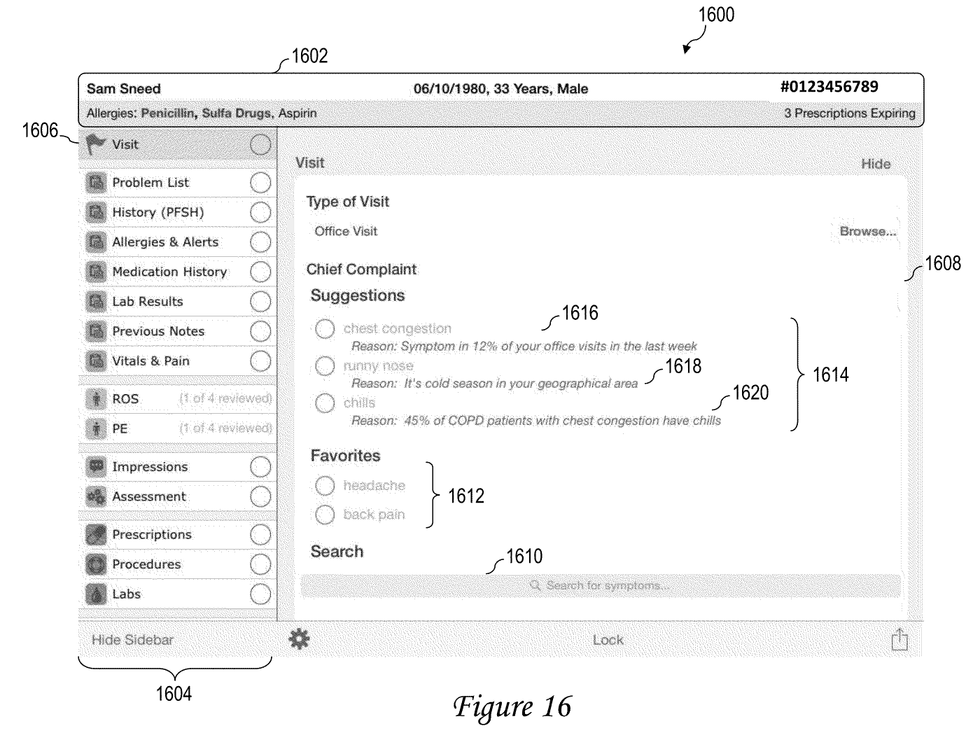

Referring now to FIG. 16, there is depicted an exemplary graphical user interface 1600 of an EHR function of a medical application 114 in which one or more chief complaints are injected by injection engine 116 based on data retrieved from one or more data sources. In the depicted example, a care provider is utilizing a client device 120 to view an EHR of a patient Sam Sneed, whose record is headed by a record summary 1602 in which the patient's name, date of birth, age, gender, unique record identifier, allergies, and prescription status are presented. Graphical user interface 1600 additionally includes a sidebar 1604 including multiple individually selectable tabs that facilitate intuitive navigation between various views of the contents of the selected patient's EHR. The tabs within sidebar 1604 include a Visit tab 1606, that when selected, causes medical application 114 to present within graphical user interface 1600 a Visit digest window 1608 in which the care provider can document the patient's visit, including the type of visit, the patient's chief complaint, etc.

In the depicted example, Visit digest window 1608 provides multiple modalities for entry of the patient's chief complaint. For example, the care provider can enter the chief complaint by searching for the patient's symptom(s) in text search box 1610. Alternatively, the care provider can select the patient's chief complaint from among multiple displayed options, in this case presented utilizing radio buttons. These options include one or more complaints listed as Favorites 1612, which the care provider (or medical application 114) has previously designated as common complaints for this patient, for a group of patients (e.g., an age group) including this patient, or for all patients and are accordingly to be presented as options for selection. The options further include one or more Suggestions 1614 injected by injection engine 116 based on data retrieved from data sources in the first and/or second set of data sources. In the depicted example, these options include option 1616, which injection engine 116 dynamically injects based on data retrieved from EMR database 121 and/or EHR database 122 indicating that “chest congestion” was a prevalent complaint in the care provider's medical practice over the last week. It should be noted that injection engine 116 is configured to explicitly include in option 1616 the reasoning behind the inclusion of option 1616 in Suggestions 1614. In the illustrated example, Suggestions 1614 further include option 1618 (“runny nose”) and option 1620 (“chills”), which injection engine 116 injects based upon data retrieved from one or more data sources in the second group of data sources (e.g., government agencies 134 (possibly including a weather and/or allergy reporting service), public health database 148, and/or educational institutions 132). Again, injection engine 116 advantageously provides an explanatory rationale for the inclusion of these options, for example, to permit the care provider to assess the applicability of these options to the patient's case.

As has been described, in some embodiments

While the present invention has been particularly shown as described with reference to one or more preferred embodiments, it will be understood by those skilled in the art that various changes in form and detail may be made therein without departing from the spirit and scope of the invention. For example, although embodiments have been described with respect to various systems and methods, those skilled in the art will appreciate that the described functionality can also be realized as a program product including program code (e.g., program instructions, commands, scripts, etc.) that, when executed by a processor of a data processing system (e.g., a computer, tablet, smartphone, etc.), direct the data processing system to perform the functions described herein. Such program code can further be employed to configure an otherwise general-purpose data processing system to serve as a special-purpose data processing system. In the program product, the program code is stored on a storage device (e.g., volatile and/or non-volatile memory, magnetic and/or optical disk, etc.), and the program product consequently comprises an article of manufacture. As an article of manufacture, the program product and the storage device are specifically defined to exclude transmission media per se and transitory propagating signals per se.

What is claimed is:

1. A method of processing in a medical information handling system, the method comprising:
the medical information handling system executing a medical application with which a client device is communicatively coupled to support presentation of a graphical user interface for the medical application in a display of the client device;
the medical information handling system executing an injection engine, wherein executing the injection engine includes:
retrieving data from a remote data source among a set of data sources including a pharmaceutical database, an insurance database, and a public health database;
correlating the retrieved data with at least one medical input entered via the graphical user interface; and
selecting a message content from among a positive message, negative message and neutral message based upon the at least one medical input and the retrieved data;
injecting into the graphical user interface at the client device a message containing the selected message content.

2. The method of claim 1, wherein the message includes a promotional message for a drug or medical device.

3. The method of claim 1, wherein:
the graphical user interface presents information regarding a patient; and
the message indicates whether a prescription is covered by an insurer of the patient.

4. The method of claim 1, wherein:
the graphical user interface presents information regarding a patient; and
the message indicates whether a prescription is contraindicated for the patient.

5. The method of claim 1, wherein the message content relates to a quality score for a care provider.

6. The method of claim 1, and further comprising the injection engine accounting for presentation of the message in the graphical user interface at the client device.

7. The method of claim 1, wherein:
the message includes a selectable element presented within the graphical user interface; and
the method further comprises:
in response to an input indicative of user selection of the selectable element, the medical application causing presentation with the display of the client device a media presentation regarding a pharmaceutical drug or medical device.

8. The method of claim 1, wherein:
the message includes a selectable element presented within the graphical user interface; and
the method further comprises:
in response to an input indicative of user selection of the selectable element, the medical application causing further presentation in the graphical user interface of a selectable element that can be selected to initiate electronic communication with a representative.

9. The method of claim 8, the method further comprises:
in response to an input indicative of user selection of the selectable element, the medical application causing further presentation in the graphical user interface of an online status of the representative.

10. The method of claim 1, wherein:
the graphical user interface presents information regarding a patient; and
the message includes a suggested chief complaint of the patient.

11. The method of claim 10, wherein the message further includes at least a portion of the retrieved data.

12. The method of claim 1, wherein the message further includes at least a portion of the retrieved data.

13. A medical information handling system, comprising:
a processor;
data storage coupled to the processor;
program code stored in the data storage and executable by the processor, wherein the program code, when executed by the processor, causes the medical information handling system to perform:
causing presentation within a display of a client device a graphical user interface of a medical application;
retrieving data from a remote data source among a set of data sources including a pharmaceutical database, an insurance database, and a public health database;
correlating the retrieved data with at least one medical input entered via the graphical user interface; and
selecting a message content from among a positive message, negative message and neutral message based upon the at least one medical input and the retrieved data;
injecting into the graphical user interface at the client device a message containing the selected message content.

14. The medical information handling system of claim 13, wherein the message includes a promotional message for a drug or medical device.

15. The medical information handling system of claim 13, wherein:
the graphical user interface presents information regarding a patient; and
the message indicates whether a prescription is covered by an insurer of the patient.

16. The medical information handling system of claim 13, wherein:
the graphical user interface presents information regarding a patient; and
the message indicates whether a prescription is contraindicated for the patient.

17. The medical information handling system of claim 13, wherein the message content relates to a quality score for a care provider.

18. The medical information handling system of claim 13, wherein the program code, when executed, further causes the medical information handling system to perform:
accounting for presentation of the message in the graphical user interface at the client device.

19. The medical information handling system of claim 13, wherein:
the message includes a selectable element presented within the graphical user interface; and
wherein the program code, when executed, further causes the medical information handling system to perform:
in response to an input indicative of user selection of the selectable element, the medical application causing presentation with the display of the client device a media presentation regarding a pharmaceutical drug or medical device.

20. The medical information handling system of claim 13, wherein:
the message includes a selectable element presented within the graphical user interface; and
wherein the program code, when executed, further causes the medical information handling system to perform:
in response to an input indicative of user selection of the selectable element, the medical application causing further presentation in the graphical user interface of a selectable element that can be selected to initiate electronic communication with a representative.

21. The medical information handling system of claim 20, wherein the program code, when executed, further causes the medical information handling system to perform:
in response to an input indicative of user selection of the selectable element, causing further presentation in the graphical user interface of an online status of the representative.

22. The medical information handling system of claim 13, wherein:
the graphical user interface presents information regarding a patient; and
the message includes a suggested chief complaint of the patient.

23. The medical information handling system of claim 22, wherein the message further includes at least a portion of the retrieved data.

24. The medical information handling system of claim 13, wherein the message further includes at least a portion of the retrieved data.

25. A program product, comprising:
a data storage device; and
program code stored in the data storage device and executable by a processor to cause a medical information handling system to perform:
causing presentation within a display of a client device a graphical user interface of a medical application;
retrieving data from a remote data source among a set of data sources including a pharmaceutical database, an insurance database, and a public health database;
correlating the retrieved data with at least one medical input entered via the graphical user interface; and
selecting a message content from among a positive message, negative message and neutral message based upon the at least one medical input and the retrieved data;
injecting into the graphical user interface at the client device a message containing the selected message content.

26. The program product of claim 25, wherein the message includes a promotional message for a drug or medical device.

27. The program product of claim 25, wherein:
the graphical user interface presents information regarding a patient; and
the message indicates whether a prescription is covered by an insurer of the patient.

28. The program product of claim 25, wherein:
the graphical user interface presents information regarding a patient; and
the message indicates whether a prescription is contraindicated for the patient.

29. The program product of claim 25, wherein the message content relates to a quality score for a care provider.

30. The program product of claim 25, wherein the program code, when executed, further causes the medical information handling system to perform:
accounting for presentation of the message in the graphical user interface at the client device.

31. The program product of claim 25, wherein:
the message includes a selectable element presented within the graphical user interface; and
wherein the program code, when executed, further causes the medical information handling system to perform:
in response to an input indicative of user selection of the selectable element, the medical application causing presentation with the display of the client device a media presentation regarding a pharmaceutical drug or medical device.

32. The program product of claim 25, wherein:
the message includes a selectable element presented within the graphical user interface; and
wherein the program code, when executed, further causes the medical information handling system to perform:
in response to an input indicative of user selection of the selectable element, the medical application causing further presentation in the graphical user interface of a selectable element that can be selected to initiate electronic communication with a representative.

33. The program product of claim 32, wherein the program code, when executed, further causes the medical information handling system to perform:
in response to an input indicative of user selection of the selectable element, causing further presentation in the graphical user interface of an online status of the representative.

34. The program product of claim 25, wherein:
the graphical user interface presents information regarding a patient; and
the message includes a suggested chief complaint of the patient.

35. The program product of claim 34, wherein the message further includes at least a portion of the retrieved data.

36. The program product of claim 25, wherein the message further includes at least a portion of the retrieved data.
